(19) United States
(12) Patent Application Publication
(10) Pub. No.: US 2010/0318953 A1
(43) Pub. Date: Dec. 16, 2010

(54) PLATFORM PROGRAMMING FOR MASS CUSTOMIZATION

(75) Inventors: Scott HR McMahon, Austin, TX (US); Brian C. Kircher, Georgetown, TX (US); Gregory A. North, Austin, TX (US)

Correspondence Address: Matthew J. Booth & Associates, PLLC;c/o CPA Global, P.O. Box 52050, 900 Second Avenue South, Suite 1560, Minneapolis, MN, 55402, US

(73) Assignee: LUMINARY MICRO, INC., Austin, TX (US)

(21) Appl. No.: 12/446,403

(22) PCT Filed: Dec. 12, 2007
(86) PCT No.: PCT/US07/87133

§ 371 Date: Apr. 20, 2009

Related U.S. Application Data
(60) Provisional application No. 60/869,841, filed on Dec. 13, 2006.

(51) Int. Cl. G06F 17/50

(52) U.S. Cl. 716/110

(57) ABSTRACT

This disclosure describes a configuration data structure (100) that describes the functional characteristics of a single semiconductor device during the mass customization of semiconductor devices. The configuration data structure (100) includes a device identification member (110), a peripheral enable member (111), an alternate function select member (112), a port bonding specification member (113), and a resource specification member (114). In addition, this disclosure describes a system (300) that specifies and controls the functional characteristics of a single semiconductor device during the mass customization of semiconductor devices. The system (300) includes the following one or more internal peripheral buses (201), one or more peripherals (320-326), a functional I/O mux (302), a configuration data structure (100), and a GPIO (212).

### TECHNICAL FIELD

The present invention relates to using a single platform semiconductor device to generate a large number of products. More specifically, the present invention relates to using a single platform semiconductor device for the mass customization of a variety of different semiconductor devices with different functional characteristics.

### BACKGROUND ART

A semiconductor company that produces microcontrollers and other related semiconductor products will typically have a large number of products with minor feature differences. To maximize the utilization of the manufacturing process, it is desirable to build a single semiconductor device that incorporated all features of the various products. And, then program the semiconductor device with the appropriate feature set before shipping the device to the customer. The STELLARIS family of microcontrollers by Luminary Micro, Inc. (Luminary Micro), the assignee of the disclosure, use the ARM Cortex M3 Intellectual Property (IP) core. In order to build a family of parts from a single die, the peripherals built around the ARM Cortex M3 core need to be able to connect to different GPIO ports depending on the configuration of the specific part. This disclosure describes the process where Luminary Micro uses a single semiconductor platform die to generate a large number of products.

This application claims the benefits of the earlier filed U.S. Provisional Application Ser. No. 60/869,841, filed 13 Dec. 2006, which is incorporated by reference for all purposes into this specification.

### BEST MODE FOR CARRYING OUT THE INVENTION

This disclosure describes a configuration data structure that describes the functional characteristics of a single semiconductor device during the mass customization of semiconductor devices. The configuration data structure comprises a device identification member, a peripheral enable member, an alternate function select member, a port bonding specification member, and a resource specification member.

This disclosure also describes a system that specifies and controls the functional characteristics of a single semiconductor device during the mass customization of semiconductor devices. The system comprises the following one or more internal peripheral buses, one or more peripherals coupled to the internal peripheral bus, a functional I/O mux coupled to the peripherals, a configuration data structure that couples to the functional I/O mux, and a GPIO coupled to the functional I/O mux.

### BRIEF DESCRIPTION OF DRAWINGS

To further aid in understanding the invention, the attached drawings help illustrate specific features of the invention and the following is a brief description of the attached drawings:

FIG. 1 illustrates one embodiment of the disclosed invention, the Configuration Data Structure.

FIG. 2 illustrates the Device Identification Member of the Configuration Data Structure.

FIG. 3 illustrates the Peripheral Enable Member of the Configuration Data Structure.

FIG. 4 illustrates the Alternate Function Select Member of the Configuration Data Structure.

FIG. 5 illustrates the Port Bonding Specification Member of the Configuration Data Structure.

FIG. 6 illustrates the Resource Specification Member of the Configuration Data Structure.

FIG. 7 illustrates the ARM GPIO Structure with the Alternate Function Interface.

FIG. 8 illustrates another embodiment of the disclosed invention that specifies and controls the functional characteristics of a single semiconductor device during the mass customization of semiconductor devices.

### DISCLOSURE OF INVENTION

This disclosure describes a single platform semiconductor device for the mass customization of a variety of different semiconductor devices with different functional characteristics. This disclosure describes numerous specific details in order to provide a thorough understanding of the present invention. For example, this disclosure describes a data structure residing in non-volatile memory, one-time programmed, that describes the functional characteristics of the underlying silicon platform. One skilled in the art will appreciate that one may practice the present invention without these specific details. Additionally, this disclosure does not describe some well known items in detail in order not to obscure the present invention.

The STELLARIS family of microcontrollers by Luminary Micro use the ARM Cortex M3 Intellectual Property (IP) core. To achieve a high utilization of manufacturing resources, the STELLARIS family of microcontrollers use a single die for multiple products. Products in the family are differentiated from each other through the contents of an on-chip, non-volatile configuration memory that specifies the features included in the final product. As an example, product features may include GPIOs, one or more peripheral devices, FLASH (non-volatile) memory, SRAM (volatile) memory, and Analog to Digital Converters (ADC) and associated sample rates. The configuration memory is programmed after the chip has been assembled, and the configuration memory assigns each chip to a product. One skilled in the art will appreciate that portion of the configuration memory may or may be accessible to the end user of the product

In one embodiment, the non-volatile configuration memory may comprise FLASH memory. One skilled in the art will appreciate that other types of non-volatile memory may be used other than FLASH memory such as EEPROMs or fuses.

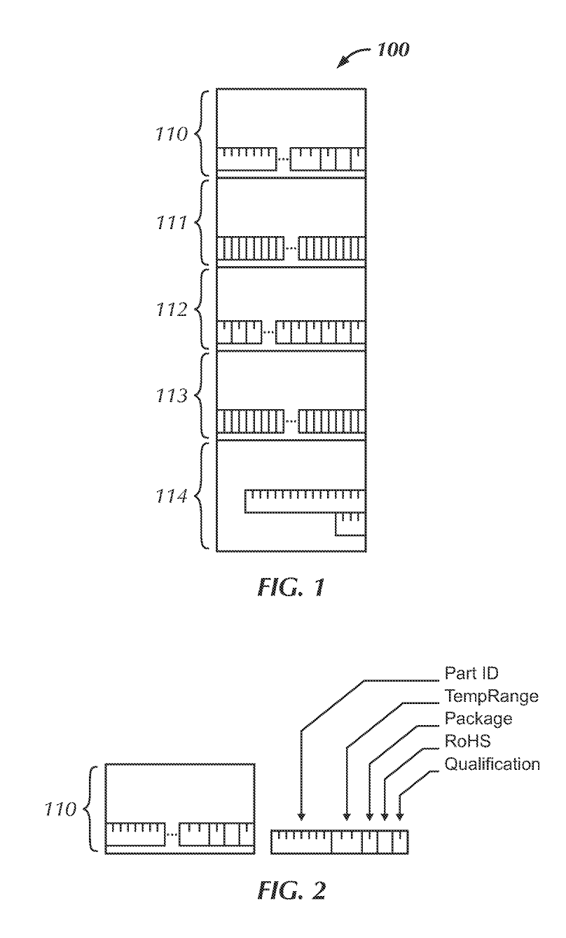

FIG. 1 illustrates one embodiment of the disclosed invention, the Configuration Data Structure 100. The configuration memory stores the configuration data structure 100. The configuration data structure 100 may include: a Device Identification Member 110, a Peripheral Enable Member 111, an Alternate Function Select Member 112, a Port Bonding Specification Member 113, and a Resource Specification Member 114, all of which are discussed in more detail below.

In general, the organization of the configuration data structure 100 is such that the data width of the configuration memory matches that of the natural data width of the processor, which in the STELLARIS family of microcontrollers, for example, is 32-bits. Padding of the configuration data structure may be inserted where appropriate to align the configuration data structure to the same data granularity.

The configuration data structure 100 in one embodiment is a separate, small block of memory that resides in the main configuration memory (or the main non-volatile memory storage) in the semiconductor device. The size of the configuration data structure depends upon the total number of integrated peripherals and system features.

The configuration data structure 100 enables the desired peripherals and features on a particular product. Using the configuration data structure 100 allows different parts to be created from a single platform die without giving the end customer the ability to use peripherals or features that are not provided on that product or part. The flexibility of the configuration data structure 100 also provides for multiple peripherals or features to use a limited number of package pins since the number of peripheral signals that want to drive or be driven by an external signal typically exceeds the number of pins on the product packages. Thus, not all peripherals can be bonded out on any particular part so several pads are assigned to more than one peripheral and the configuration data structure 100 determines which of the peripherals are actually able to use the pad. In one embodiment one the invention, when one bit of the configuration data structure 100 is set to one, the peripheral is enabled and allowed to function. When set to zero, the peripheral is disabled and does not function. And, peripherals that simply do not exist on the die have their corresponding bits set to zero.

During the initial power on configuration or later reset of the configuration data structure 100, a state machine copies the programmed values of the configuration data structure from the configuration memory. The state machine generates read access cycles to the configuration memory and copies the returned data values to internal registers (or flip flops). The registers are of two classes: one class is made available to the end-user for use by software and provides configuration information, and the other class are connected directly to peripherals and features and are not accessible to software. These register bits then connect to their applicable peripherals and functional units to control their operation. One skilled in the art will appreciate the state machine could be part of a power on loader or load sequence that initially configures the product for use. In addition, one skilled in the art will appreciate that the end user of the product may or may not have access to the state machine during the initial power on figuration or later reset. Further, one skilled in the art will appreciate that the internal registers may reside anywhere in the design.

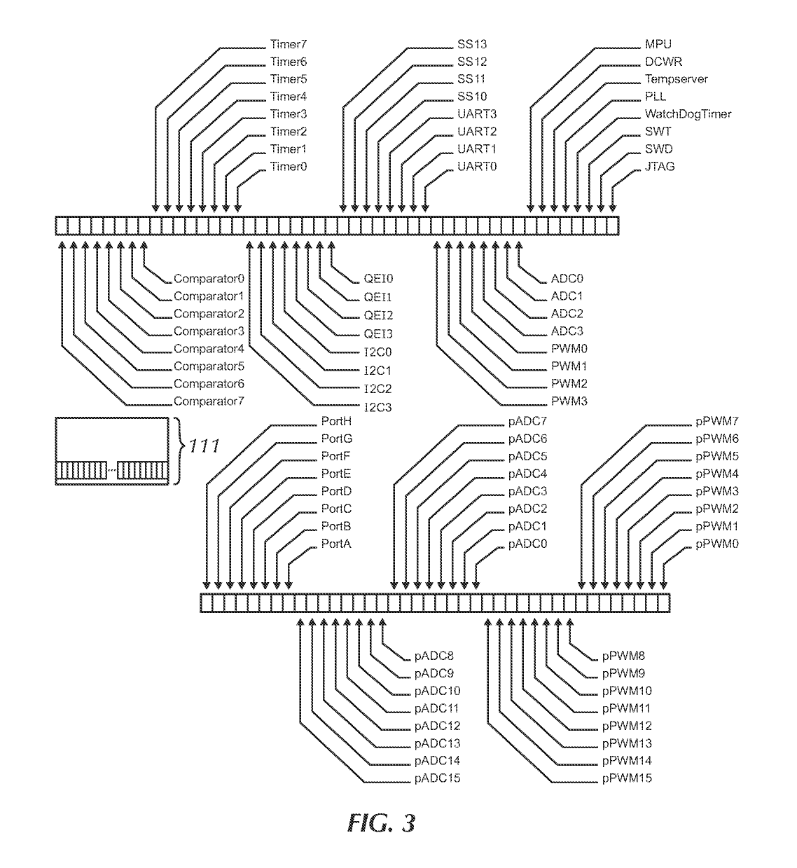

FIG. 2 illustrates the device identification member 110 of the configuration data structure 100. The device identification member 110 identifies each individual product within the family of semiconductor products. The bits of this member are copied to user-accessible, read-only, memory-mapped registers within the microcontroller. Software running on the microcontroller can inspect these registers to determine the specific product identity and other information regarding the product and the state of the product. In one embodiment, the device identification member 110 contains information for the part identification (Part Id), the temperature range of the package (TempRange), the type of package (Package), RoHS status (RoHS), and the qualification status of the product (Qualification). One skilled in the arts will appreciate that one may include a variety other of device identification information within the invention.

FIG. 3 illustrates the peripheral enable member 111 of the configuration data structure 100. The peripheral enable member 111 specifies the set of peripherals that are provided or made available in the individual product. This member contains a large bit-vector to control peripheral functions. Each bit of the bit vector specifies the presence or absence of a corresponding peripheral. If a bit is set, the corresponding peripheral is included in the product. If clear, the peripheral is not included in the product and is made non-functional and inaccessible to software. This bit vector is copied across a set of user-accessible, read-only, memory-mapped registers. Software running on the microcontroller can inspect these registers to determine the peripheral availability. Other registers that control peripheral functions (e.g. for enabling the clocks to, or for initiating a peripheral-specific reset) use the same bit lanes. In other words, if bit 2 of a given user-accessible register indicates that UART2 is present, bit 2 will also control the same peripheral for other registers that affect the function of that peripheral.

One skilled in the art will appreciate that the value of each peripheral enable bit may be used to control the availability of a peripheral by a number of methods. These methods include, for example, disabling power to the peripheral, disabling clocks to the peripheral, holding the peripheral in reset, and preventing read/write access to the peripheral by disabling the address decode of the peripheral.

One embodiment of the invention comprises information for the peripherals as follows: Timers (Timer0-Timer7), SSIs (SSI0-SSI3), UARTs (UART0-UART3), Comparators (Compartor0-Comparator7), QEIs (QEI0-QEI3), I2Cs (I2C0-I2C3), ADCs (ADC0-ADC3) with data ports (pADC0-pADC15), PWMs (PWM0-PWM3) with data ports (pPWM0-pPWM15), Ports (PortA-PortH). In addition, this embodiment includes information for other peripherals that include: MPU, DCWR, TempSensor, PLL, WatchDogTimer, SWT, SWD, and JTAG.

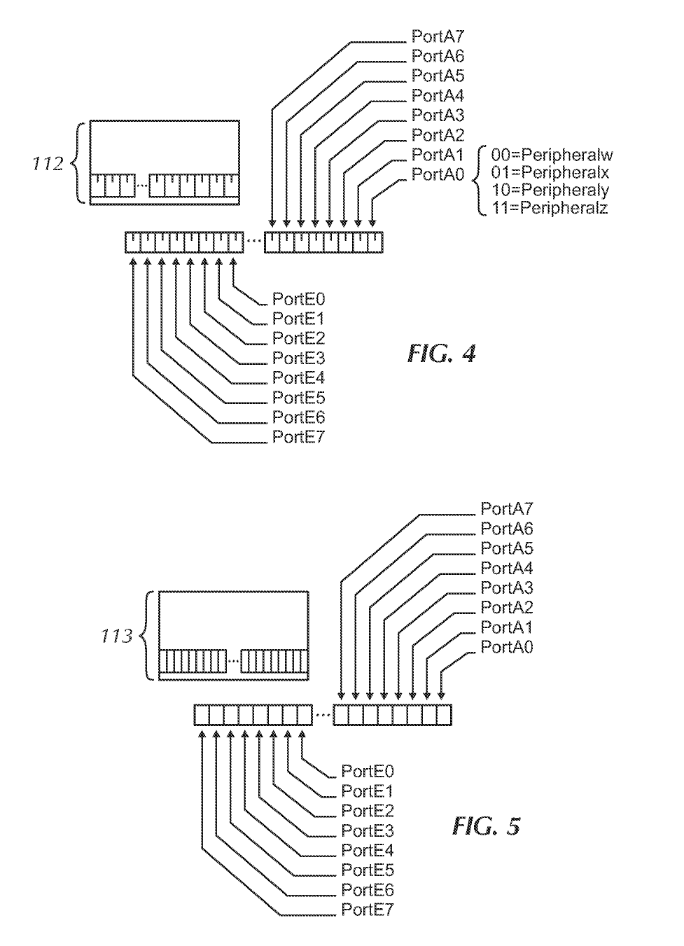

FIG. 4 illustrates the alternate function select member 112 of the configuration data structure 100. The alternate function select 112 specifies the pairing of internal peripheral signals (PortA0-PortA7) with the product package pins (PortE0-PortE7) and GPIO ports. One embodiment of the invention illustrates an implementation for the bit field size as being 2 bits such as the following: 00 representing Peripheral w, 01 representing Peripheral x, 10 representing Peripheral y, and 11 representing Peripheral z. One skilled in the art will appreciate that the bit field size that controls each element of the functional I/O mux 302 may be of arbitrary size as well as the specific encoding method for the various peripherals.

FIG. 5 illustrates the port bonding specification member 113 of the configuration data structure 100. The port bonding specification member 113 specifies whether a package pin/GPIO port (on a pin by pin basis) is available for use on an individual product. A further method to achieve product differentiation is to remove functionality. In the case of Stellaris device pins, this is accomplished by marking pins, on an individual pin-level granularity, as not available, or NO CONNECT. The port bonding specification member 113 contains a bit vector, each bit of which indicates the state of a corresponding GPIO pin. If a port binding bit is set, the pin, and corresponding GPIO, is available for use, otherwise the pin is deactivated and is virtually unwired (or unbonded). One embodiment of the invention comprises information for internal ports (PortA0-PortA7) and package pins (PortE0-PortE7).

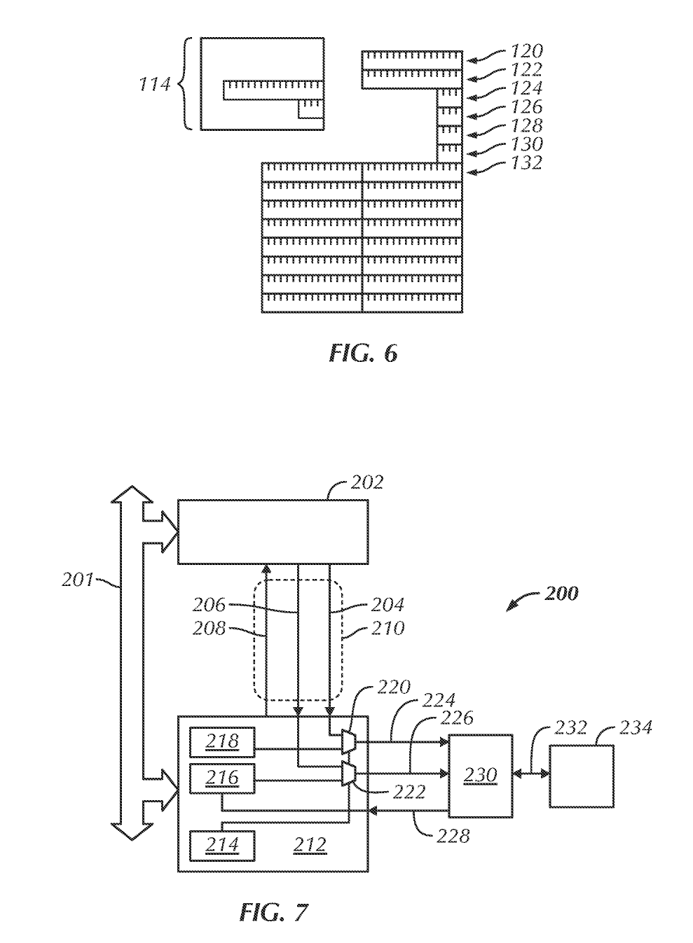

FIG. 6 illustrates the resource specification member 114 of the configuration data structure 100. The resource specification member 114 specifies the characteristics of internal resources. One skilled in the art will appreciate that there are variety of internal resources available for specification in this member. One embodiment of the invention may specify the following attributes: the size of the FLASH memory 120, the size of the SRAM memory 122, the minimum clock divider 124, the maximum ADC sampling rate 126, different ADC clock dividers 128 and 130, and the crystal-to-PLL conversion table 132. Other attributes are also possible. For example, there may be attributes that allow access to debug features or test circuits that may or may not be available to the end user of the product.

FIG. 7 illustrates the ARM GPIO structure 200 with the alternate function interface 210. In addition to the Cortex M3 core, ARM provides an intellectual property block (predesigned logic for license) that implements a general-purpose I/O function. GPIO functionality allows software to control the logic state of a pin. The ARM GPIO structure 200 implements GPIO bits in 8-bit sized quanta that are accessed through byte transfers. The ARM GPIO structure 200 also provides an alternate function port per GPIO bit. This port allows a single peripheral signal to be connected through the GPIO, and allows software the option of connecting the alternate function peripheral signal to the pin. If the peripheral is not used in the final application, the pin is configured for GPIO function, otherwise if the peripheral is used in the final application the pin is configured for the alternate function.

The ARM GPIO structure 200 includes the peripheral data bus 201 that couples to a individual peripheral 202 and GPIO 212. The alternate function interface couples the peripheral 202 to GPIO 212 with the following control signals peripheral input 208, peripheral output 206, and peripheral direction 204. The GPIO 212 contains a control register 214, a data register 216, a direction register 218, and multiplexors 220 and 222. The GPIO 212 couples to the driver interface 230 with data in 228, data out 226, and direction signal 224. The driver interface 230 couples to bond pad 234 through connection 232.

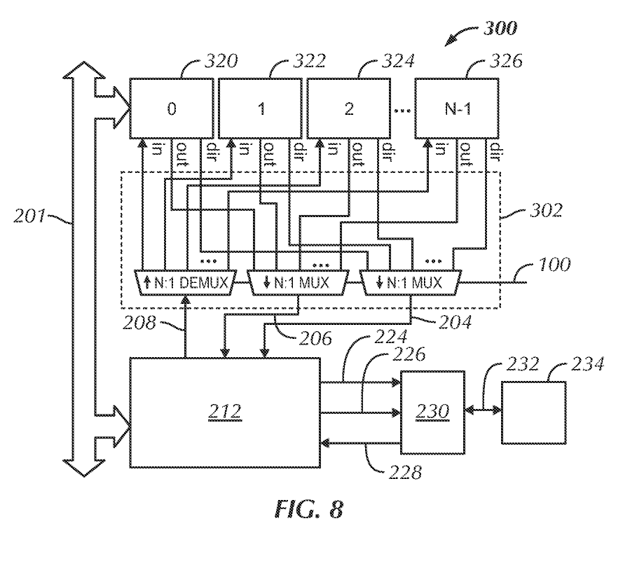

FIG. 8 illustrates another embodiment of the disclosed invention which is a system 300 that specifies and controls the functional characteristics of a single semiconductor device during the mass customization of semiconductor devices. In order to build a family of parts from a single die, the peripherals built around the ARM Cortex M3 core need to be able to connect to different GPIO ports depending on the configuration of the specific part. The I/O structure of Stellaris microcontroller products use the basic ARM GPIO intellectual property that is illustrated in FIG. 7. However, instead of connecting a peripheral to a GPIO pin's alternate function interface as previously illustrated, a set of peripherals 320-326 is connected to the alternate function interface through a bidirectional multiplexer structure called the functional I/O mux 302. The control of the functional I/O mux is static. It is loaded from the configuration memory at reset, and held throughout the operation of the device. In addition, one skilled in the arts will appreciate that it is possible to have one or more internal peripheral buses 201 to couple to the set of peripherals 320-326.

In a given product there is one alternate signal provided as the alternate function for each pin. However, the product-specific alternative is the result of selecting among a set of platform alternatives. The selection is specified in the configuration data structure 100 in the alternate function select member 112. Each pin has an encoded bit field that describes which peripheral signal is designated as the alternate function for the GPIO, and it is connected to the corresponding GPIO port through the functional I/O mux 302. The functional I/O mux 302 couples to the configuration data structure 100 via internal registers as previously described. The alternate function bit fields are copied from the configuration memory at reset and stored in user-inaccessible registers in the functional I/O mux 302 (N:1 MUXs and N:1 DEMUX).

One embodiment of the invention is system 300 that includes the peripheral data bus 201 that couples to an N number of peripherals 320 through 326. Peripheral data bus 201 additionally couples to GPIO 212. Each peripheral 320 through 326 includes its own input, output, and direction signal. The functional I/O mux 302 couples the input/output/direction signal of peripherals 320-326 to the following control signals GPIO 212: peripheral input 208, peripheral output 206, and peripheral direction 204. The GPIO 212 couples to the driver interface 230 with data in 228, data out 226, and direction signal 224. The driver interface 230 couples to bond pad 234 through connection 232.

To summarize, this disclosure describes a configuration data structure that describes the functional characteristics of a single semiconductor device during the mass customization of semiconductor devices. The configuration data structure comprises a device identification member, a peripheral enable member, an alternate function select member, a port bonding specification member, and a resource specification member.

This disclosure also describes a system that specifies and controls the functional characteristics of a single semiconductor device during the mass customization of semiconductor devices. The system comprises the following: one or more internal peripheral buses; one or more peripherals coupled to the internal peripheral buses; a functional I/O mux coupled to the peripherals; a configuration data structure that describes the functional characteristics of a semiconductor device that couples to the functional I/O mux; and a GPIO coupled to the functional I/O mux.

Other embodiments of the invention will be apparent to those skilled in the art after considering this specification or practicing the disclosed invention. The specification and examples above are exemplary only, with the true scope of the invention being indicated by the following claims.

We claim the following invention:

1. A configuration data structure that describes the functional characteristics of a single semiconductor device during the mass customization of semiconductor devices, comprising:
a device identification member;
a peripheral enable member;
an alternate function select member;
a port bonding specification member;
a resource specification member; and
wherein said device identification member, said peripheral enable member, said alternate function select member, said port bonding specification member; and said resource specification member of the configuration data structure describe the functional characteristics of the single semiconductor device during the mass customization of semiconductor devices.

2. A method to manufacture a configuration data structure that describes the functional characteristics of a single semiconductor device during the mass customization of semiconductor devices, comprising:
providing a device identification member, a peripheral enable member, an alternate function select member, a port bonding specification member, and a resource specification member in the configuration data structure; and
wherein the configuration data structure describes the functional characteristics of the single semiconductor device during the mass customization of semiconductor devices.

3. A method to use a configuration data structure that provides the functional characteristics of a single semiconductor device during the mass customization of semiconductor devices, comprising:
using a device identification member, a peripheral enable member, an alternate function select member, a port bonding specification member, and a resource specification member in the configuration data structure; and
wherein the configuration data structure provides the functional characteristics of the single semiconductor device during the mass customization of semiconductor devices.

4. A system that specifies and controls the functional characteristics of a single semiconductor device during the mass customization of semiconductor devices, comprising:
one or more internal peripheral buses;
one or more peripherals coupled to said internal peripheral buses;
a functional I/O mux coupled to said peripherals;
a configuration data structure that describes the functional characteristics of the semiconductor device that couples to said functional I/O mux; and
a GPIO coupled to said functional I/O mux.

5. A method to manufacture a system that specifies and controls the functional characteristics of a single semiconductor device during the mass customization of semiconductor devices, comprising:
providing one or more internal peripheral buses;
coupling one or more peripherals to said internal peripheral buses;
coupling a functional I/O mux to said peripherals;
coupling a configuration data structure that describes the functional characteristics of the semiconductor device to said functional I/O mux; and
coupling a GPIO to said functional I/O mux.

6. A method to use a system that specifies and controls the functional characteristics of a single semiconductor device during the mass customization of semiconductor devices, comprising:
providing one or more internal peripheral buses;
using one or more peripherals coupled to said internal peripheral buses;
using a functional I/O mux coupled to said peripherals;
using a configuration data structure that describes the functional characteristics of a semiconductor device that couples to said functional I/O mux; and
using a GPIO coupled to said functional I/O mux.
